(19) United States
(12) Patent Application Publication
(10) Pub. No.: US 2008/0193395 A1
(43) Pub. Date: Aug. 14, 2008

(54) COSMETIC PREPARATION WITH VINYLPYRROLIDONE/ACRYLIC ACID COPOLYMER

(75) Inventors: Sophie VIALA, Hamburg (DE); Andreas CLAUSEN, Hamburg (DE); Celina STORBECK, Boenningstedt (DE); Mirko TESCH, Hamburg (DE); Kerstin SKUBSCH, Pinneberg (DE)

Correspondence Address: GREENBLUM & BERNSTEIN, P.L.C., 1950 ROLAND CLARKE PLACE, RESTON, VA, 20191, US

(73) Assignee: BEIERSDORF AG, Hamburg (DE)

(21) Appl. No.: 11/674,879

(22) Filed: Feb. 14, 2007

(51) Int. Cl. A61Q 17/04

(52) U.S. Cl. 424/59

(57) ABSTRACT

Cosmetic preparation containing
a. one or more water-soluble UV photoprotective filters selected from the group of the compounds 2-phenylbenzimidazole-5-sulfonic acid and the sodium, potassium and triethanolammonium salts thereof as well as phenylene-1,4-bis-(2-benzimidazyl)-3,3′-5,5′-tetrasulfonic acid and the sodium, potassium and triethanolammonium salts thereof,
b. a copolymer of vinylpyrrolidone and acrylic acid.

The trend away from genteel pallor towards “healthy, sporty brown skin” has been unbroken for years. In order to attain this, people expose their skin to solar radiation since this brings about pigment formation in the sense of melanin formation. However, the ultraviolet radiation of sunlight also has a harmful effect on the skin. Besides the acute damage (sunburn), long-term damage, such as suffering from an increased risk of skin cancer in cases of excessive irradiation with light from the UVB region (wavelength: 280-320 nm), arises. Moreover, the excessive effect of UVB and UVA radiation (wavelength: 320-400 nm) leads to a weakening of the elastic and collagenous fibers of connective tissue. This leads to numerous phototoxic and photoallergic reactions and results in premature skin ageing.

To protect the skin, a number of photoprotective filter substances have therefore been developed which can be used in cosmetic preparations. These UVA and UVB filters are summarized in most industrialized countries in the form of positive lists such as Annex 7 of the Cosmetics Directive.

However, the large number of sunscreen agents commercially available should not conceal the fact that these preparations of the prior art have a number of disadvantages.

Preparations that contain the water-soluble UV photoprotective filters selected from the group of the compounds 2-phenylbenzimidazole-5-sulfonic acid and the sodium, potassium or triethanolammonium salts thereof or phenylene-1,4-bis-(2-benzimidazyl)-3,3′-5,5′-tetrasulfonic acid and the sodium, potassium or triethanolammonium salts thereof, and thus have a high electrolyte content are difficult to formulate as an emulsion. Emulsions of this type can be produced with some stability according to the prior art only through the combination of several thickeners or through the use of an emulsifier system specially developed for the respective formula. The preparations produced in this manner then as a rule exhibit uncosmetic properties. These emulsions then have a gritty appearance. When they are removed from a container, threads form and they feel sticky and unpleasant on the skin.

The object of the present invention was therefore to eliminate the disadvantages of the prior art. Furthermore, the object was to develop stable cosmetic emulsions (or dispersions) with a high content of water-soluble UV photoprotective filters on an electrolyte basis which have an attractive feel when applied to the skin.

These objects are surprisingly attained through a cosmetic preparation containing
a) one or more water-soluble UV photoprotective filter selected from the group of the compounds 2-phenylbenzimidazole-5-sulfonic acid and the sodium, potassium and triethanolammonium salts thereof as well as phenylene-1,4-bis-(2-benzimidazyl)-3,3′-5,5′-tetrasulfonic acid and the sodium, potassium or triethanolammonium salts thereof,
b) a copolymer of vinylpyrrolidone and acrylic acid.

Surprisingly, the preparations according to the invention can be produced in a stable manner with a reduced amount of emulsifiers and/or co-emulsifiers (e.g., fatty alcohols). In part preparations (emulsions/dispersions) can even be produced in a stable manner if the use of co-emulsifiers (fatty alcohols) is dispensed with.

It is advantageous according to the invention if the preparation according to the invention contains the water-soluble UV photoprotective filters in a concentration of 0.1 to 20% by weight, based on the total weight of the preparation and preferred according to the invention if the preparation according to the invention contains the water-soluble UV photoprotective filters in a concentration of 0.1 to 10% by weight, based on the total weight of the preparation.

It is advantageous according to the invention if the preparation according to the invention contains the copolymer of vinylpyrrolidone and acrylic acid in a concentration of 0.1 to 10% by weight and preferably in a concentration of 0.1 to 5% by weight, in each case based on the total weight of the preparation.

Embodiments of the present invention that are advantageous according to the invention are characterized in that the weight ratio of water-soluble UV photoprotective filters to copolymers is 1:15 to 15:1.

It is advantageous in terms of the present invention if the copolymer according to the invention is cross-linked with pentaerythritol triallyl ether. In this embodiment it is preferred according to the invention if the polymer contains 25-80% by weight of vinylpyrrolidone, 20-80% by weight of acrylic acid and 0.4-2% by weight of pentaerythritol triallyl ether.

Embodiments of the present invention that are advantageous according to the invention are characterized in that the preparation is present in the form of an emulsion, preferably in the form of an O/W emulsion.

Advantageously according to the invention the concentration of the emulsifier system in the preparation is 0.01-6% by weight based on the total weight of the preparation.

Advantageously according to the invention the preparation according to the invention additionally contains one or more further UV filters selected from the group of the compounds 1,4-di(2-oxo-10-sulfo-3-bornylidenemethyl)benzene and salts thereof, 2,2′-methylenebis(6-(2H-benzotriazol-2-yl)-4-(1,1,3,3-tetramethylbutyl)phenol); 2-(2H-benzotriazol-2-yl)-4-methyl-6-[2-methyl-3-[1,3,3,3-tetramethyl-1-[(trimethylsilyl)oxy]-disiloxanyl]propyl]phenol; 3-(4-methylbenzylidene)camphor; 3-benzylidenecamphor; ethylhexyl salicylate; terephthalidene dicamphor sulfonic acid; 4-(dimethylamino)benzoic acid(2-ethylhexyl)ester; 4-(dimethylamino)benzoic acid-amyl ester; 4-methoxybenzalmalonic acid di(2-ethylhexyl)ester; 4-methoxycinnamic acid (2-ethylhexyl)ester; 4-methoxycinnamic acid isoamyl ester; 2-hydroxy-4-methoxybenzo-phenone, 2-hydroxy-4-methoxy-4′-methylbenzophenone; 2,2′-dihydroxy-4-methoxybenzophenone; 2-(4′-diethylamino-2′-hydroxybenzoyl)-benzoic acid hexyl ester 4-(tert.butyl)-4′-methoxydibenzoylmethane; homomenthyl salicylate; 2-ethylhexyl 2-hydroxybenzoate; 2-ethylhexyl 2-cyano-3,3-diphenylacrylate; dimethicodiethyl benzalmalonate; (3-(4-(2,2-bis-ethoxycarbonylvinyl)-phenoxy)propenyl)-methoxysilane/dimethylsiloxane copolymer; 2,4-bis-{[4-(2-ethylhexyloxy)-2-hydroxy]-phenyl}-6-(4-methoxyphenyl)-1,3,5-triazine (INCI: bis-ethylhexyloxyphenol methoxyphenyl triazine); dioctylbutylarnidotriazone (INCI: dioctylbutamidotriazone); 2,4-bis-[5-1(dimethylpropyl)benzoxazol-2-yl-(4-phenyl)-imino]-6-(2-ethylhexyl)-imino-1,3,5-triazine with the (CAS no. 288254-16-0); tris(2-ethylhexyl) 4,4′,4″-(1,3,5-triazine-2,4,6-triyltriimino)trisbenzoate (also: 2,4,6-tris-][aniline-(p-carbo-2′-ethyl-1′-hexyloxy)]-1,3,5-triazine (INCI: ethylhexyl triazone); 2,4,6-tribiphenyl-4-yl-1,2,3-triazine; merocyanine; titanium dioxide; zinc oxide in a concentration of 0.01 to 40% by weight and preferably in a concentration of 1 to 30% by weight based on the total weight of the preparation.

The pigments (titanium dioxide, zinc oxide) can advantageously be surface-treated (coated), whereby, e.g., a hydrophilic, amphiphilic or hydrophobic character is to be formed or retained. This surface treatment can consist in providing the pigments with a thin hydrophilic and/or hydrophobic inorganic and/or organic layer in processes known per se. The different surface coatings can also contain water for the purposes of the present invention.

Inorganic surface coatings for the purposes of the present invention can consist of aluminum oxide (Al₂O₃), aluminum hydroxide Al(OH)₃, or aluminum oxide hydrate (also: alumina, CAS No.: 1333-84-2), sodium hexametaphosphate (NaPO₃)₆, sodium metaphosphate (NaPO₃)ₙ, silicon dioxide (SiO₂) (also: silica, CAS No.: 7631-86-9), barium sulfate (BaSO₄) or iron oxide (Fe₂O₃). These inorganic surface coatings may be present on their own, in combination and/or in combination with organic coating materials.

Organic surface coatings for the purposes of the present invention can comprise vegetable or animal aluminum stearate, vegetable or animal stearic acid, lauric acid, dimethylpolysiloxane (also: dimethicone), methylpolysiloxane (methicone), simethicone (a mixture of dimethylpolysiloxane with an average chain length of from 200 to 350 dimethylsiloxane units and silica gel) or alginic acid. These organic surface coatings may be present on their own, in combination and/or in combination with inorganic coating materials.

Advantageously according to the invention, the preparations according to the invention are free from p-methylbenzylidene camphor.

Embodiments of the invention that are advantageous according to the invention are characterized in that the preparation contains further water-soluble salts in a concentration of 0.001 to 10% by weight, based on the total weight of the preparation.

According to the invention “water-soluble salts” mean salts in which at least 1 g of salt can be dissolved in 100 g of water at 20° C.

Advantageously, the aqueous phase of the preparations according to the present invention may optionally include customary cosmetic auxiliaries, such as, e.g., alcohols, in particular those with a low carbon number, preferably ethanol and/or isopropanol, diols or polyols of a low carbon number, as well as ethers thereof, preferably butylene glycol, caprylyl glycol, hexane diol, pentylene glycol, propylene glycol, 2-methylpropane-1,3-diol, glycerin, ethylene glycol, ethylene glycol monoethyl or monobutyl ether, propylene glycol monomethyl, monoethyl, or monobutyl ether, diethylene glycolmonomethyl or monoethyl ether and analogous products, polymers, foam stabilizers.

Advantageously according to the invention the preparation according to the invention contains one or more film formers. For the purposes of the present invention film formers are substances of differing composition that are characterized by the following characteristic: if a film former is dissolved in water or other suitable solvents and the solution is then applied to the skin, after the solvent has evaporated a film is formed, which essentially has a protective function.

It is particularly advantageous to select the film formers from the group of polymers based on polyvinylpyrrolidone (PVP),

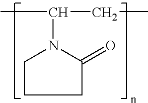

Particular preference is given to copolymers of polyvinylpyrrolidone, for example, the PVP hexadecene copolymer and the PVP eicosene copolymer, which are available under the trade names Antaron V216 and Antaron V220 from GAF Chemicals Cooperation.

Also advantageous are further polymer film formers, such as, e.g., sodium polystyrene sulfonate, which is available from the National Starch and Chemical Corp. under the trade name Flexan 130, and/or polyisobutene, available from Rewo under the trade name Rewopal PIB1000. Other suitable polymers are, e.g., polyacrylamide (Seppigel 305), polyvinyl alcohols, PVP, PVP/VA copolymers, polyglycols. Also advantageous is the use of hydrogenated castor oil dimer dilinoleate (CAS 646054-62-8), which is available from Kokyu Alcohol Kogyo under the name Risocast DA-H, or also PPG-3 benzylethermyristate (CAS 403517-45-3), which is available under the trade name Crodamol STS from Croda Chemicals, and Dermacryl 79 (acrylates/octylacrylamide copolymer) from National Starch.

The oil phase of the preparation according to the invention is advantageously chosen from the group of polar oils, for example from the group of lecithins and of fatty acid triglycerides, namely the triglycerol esters of saturated and/or unsaturated, branched and/or unbranched alkanecarboxylic acids of a chain length from 8 to 24, in particular 12 to 18, carbon atoms. The fatty acid triglycerides can, for example, advantageously be chosen from the group of synthetic, semi-synthetic and natural oils, such as, for example, cocoaglyceride, olive oil, sunflower oil, soya oil, peanut oil, rapeseed oil, almond oil, palm oil, coconut oil, castor oil, wheatgerm oil, grapeseed oil, thistle oil, evening primrose oil, macadamia nut oil, and the like.

Also advantageous according to the invention are, for example, natural waxes of animal and vegetable origin, such as, for example, beeswax and other insect waxes, and berry wax, shea butter and/or lanolin (wool wax).

Further advantageous polar oil components can also be chosen for the purposes of the present invention from the group of esters of saturated and/or unsaturated, branched and/or unbranched alkanecarboxylic acids of a chain length from 3 to 30 carbon atoms and saturated and/or unsaturated, branched and/or unbranched alcohols of a chain length from 3 to 30 carbon atoms, and from the group of esters of aromatic carboxylic acids and saturated and/or unsaturated, branched and/or unbranched alcohols of a chain length from 3 to 30 carbon atoms. Such ester oils can then advantageously be chosen from the group comprising phenethylbenzoate, octyl palmitate, octyl cocoate, octyl isostearate, octyl dodecyl myristate, octyldodecanol, cetearyl isononoanoate, isopropyl myristate, isopropyl palmitate, isopropyl stearate, isopropyl oleate, n-butyl stearate, n-hexyl laurate, n-decyl oleate, isooctyl stearate, isononyl stearate, isononyl isononanoate, 2-ethylhexyl palmitate, 2-ethyhexyl laurate, 2-hexyldecyl stearate, 2-octyldodecyl palmitate, stearyl heptanoate, oleyl oleate, oleyl erucate, erucyl oleate, erucyl erucate, tridecyl stearate, tridecyl trimellitate, and synthetic, semisynthetic and natural mixtures of such esters, such as, for example, jojoba oil.

In addition, the oil phase can advantageously be chosen from the group of dialkyl ethers and dialkyl carbonates, for example dicaprylyl ether (Cetiol OE) and/or dicaprylyl carbonate, for example that available under the trade name Cetiol CC from Cognis, being advantageous.

It is also preferred the oil component or components from the group consisting of isoeicosane, neopentyl glycol diheptanoate, propylene glycol dicaprylate/dicaprate, caprylic/capric/diglyceride succinate, butylene glycol dicaprylate/dicaprate, C₁₂₋₁₃ alkyl lactate, di-C₁₂₋₁₃ alkyl tartrate, myristyl myristate, isodecyl neopentanoate, triisostearin, dipentaerythrityl hexcaprylate/hexacaprate, propylene glycol monoiostearate, tricaprylin, dimethyl isosorbide. It is particularly advantageous if the oil phase of the formulations according to the invention has a content of C₁₂₋₁₅-alkyl benzoate or consists entirely thereof.

Advantageous oil components are also, for example, butyloctyl salicylate (for example that available under the trade name Hallbrite BHB from CP Hall), hexadecyl benzoate and butyloctyl benzoate and mixtures thereof (Hallstar AB) and/or diethylhexyl naphthalate (Hallbrite TQ or Corapan TQ from Symrise).

Any desired mixtures of such oil and wax components can also be used advantageously for the purposes of the present invention.

In addition, the oil phase can likewise advantageously also comprise nonpolar oils, for example those which are chosen from the group of branched and unbranched hydrocarbons and hydrocarbon waxes, in particular mineral oil, Vaseline (petrolatum), paraffin oil, squalane and squalene, polyolefins, hydrogenated polysiobutenes C13-16 isoparaffin, cyclometicone, dimethicone, phenyltrimethicone and isohexadecane. Among the polyolefins, polydecenes are the preferred substances.

The preparations according to the invention can also advantageously comprise one or more substances from the following group of siloxane elastomers, for example in order to increase the water resistance and/or the light protection factor of the products:
(a) siloxane elastomers which contain the units R₂SiO and RSiO_{1.5} and/or R₃SiO_{0.5} and/or SiO₂,
where the individual radicals R, in each case independently of one another, are hydrogen, C₁₋₂₄-alkyl (such as, for example, methyl, ethyl, propyl) or aryl (such as, for example, phenyl or tolyl), alkenyl (such as, for example, vinyl), and the weight ratio of the units R₂SiO to RSiO_{1.5} is chosen from the range from 1:1 to 30:1;
(b) siloxane elastomers which are insoluble and swellable in silicone oil and which are obtainable by the addition reaction of an organopolysiloxane (1) which contains silicon-bonded hydrogen with an organopolysiloxane (2) which contains unsaturated aliphatic groups,
where the quantitative amounts used are chosen such that the amount of hydrogen in the organopolysiloxane (1) or in the unsaturated aliphatic groups of the organopolysiloxane (2)
   is in the range from 1 to 20 mol % when the organopolysiloxane is noncyclic and
   is in the range from 1 to 50 mol % when the organopolysiloxane is cyclic.

For the purposes of the present invention, the siloxane elastomer or elastomers are advantageously present in the form of spherical powders or in the form of gels.

Siloxane elastomers present in the form of spherical powders which are advantageous according to the invention are those with the INCI name Dimethicone/Vinyl Dimethicone Crosspolymer, for example that available from DOW CORNING under the trade names DOW CORNING 9506 Powder.

It is particularly preferred when the siloxane elastomer is used in combination with oils from hydrocarbons of animal and/or vegetable origin, synthetic oils, synthetic esters, synthetic ethers or mixtures thereof.

On the one hand, it is advantageous according to the invention if the preparation is present in the form of an O/W emulsion. In this case it is particularly preferred according to the invention if the preparation contains one or more O/W emulsifiers from the group of the compounds glyceryl stearate citrate, glyceryl stearate (self-emulsifying), stearic acid, stearate salts, polyglyceryl-3-methylglycose distearate, ceteareth-20, PEG-40 stearate, PEG-100 stearate, sodium stearoyl glutamate and sodiumcetearyl sulfate.

On the other hand, it is advantageous according to the invention if the preparation is present in the form of a W/O emulsion. In this case, it is particularly preferred according to the invention if the preparation contains one or more W/O emulsifiers selected from the group of the compounds polyglyceryl-2-dipolyhydroxystearate, PEG-30 dipolyhydroxystearate, cetyl dimethicone copolyol, polyglyceryl-3 diisostearate.

Furthermore, the preparations according to the invention can furthermore advantageously also contain self-tanning substances, such as, e.g., dihydroxyacetone and/or melanin derivatives in concentrations from 1% by weight to 10% by weight based on the total weight of the preparation.

In addition, the preparations according to the invention can advantageously also comprise repellents for protection against flies, ticks and spiders and the like. For example, N,N-diethyl-3-methylbenzamide (trade name: Meta-delphene, “DEET”), dimethyl phthalate (trade name: Palatinol M, DMP), 1-piperidinecarboxylic acid-2-(2-hydroxyethyl)-1-methylpropylester and in particular ethyl 3-(N-n-butyl-N-acetylamino)propionate (available under the trade name Insekt Repellent® 3535 from Merck). The repellents can either be used individually or in combination.

Moisturizers is the term used to refer to substances or mixtures of substances which impart to cosmetic or dermatological preparations the property, following application or distribution on the surface of the skin, of reducing moisture release by the horny layer (also called trans-epidermal water loss (TEWL)) and/or of positively influencing hydration of the horny layer.

Advantageous moisturizers for the purposes of the present invention are, for example, glycerol, lactic acid and/or lactates, in particular sodium lactate, butylene glycol, propylene glycol, biosaccharide gum-1, glycine soya, hydroxyethyl urea, ethylhexyloxyglycerol, pyrrolidone-carboxylic acid and urea. In addition, it is particularly advantageous to use polymeric moisturizers from the group of water-soluble or water-swellable or water-gelable polysaccharides. Hyaluronic acid, chitosan, and/or a fucose-rich polysaccharide, which is filed in the Chemical Abstracts under the registry number 178463-23-5 and which is available, for example, under the name Fucogel® 1000 by SOLABIA S. A., for example, are particularly advantageous. Moisturizers can advantageously also be used as anti-wrinkle active ingredients for protection against changes in the skin, as arise, for example, during skin aging.

It is advantageous for the purposes of the present invention if the preparation according to the invention contains one or more humectants in a total concentration of 0.1 to 30% by weight and preferably in a total concentration of 0.5 to 20% by weight, respectively based on the total weight of the preparation.

The cosmetic or dermatological preparations according to the invention can also advantageously, but not necessarily, comprise fillers, which, for example, further improve the sensory and cosmetic properties of the formulations and, for example, bring about or enhance a velvety or silky feel on the skin. Advantageous fillers for the purposes of the present invention are starch and starch derivatives (such as, for example, tapioca starch, distarch phosphate, aluminum or sodium starch octenylsuccinate and the like), pigments which have neither a primarily UV filter effect nor a coloring effect (such as, for example, boron nitride etc.), and/or Aerosils® (CAS No. 7631-86-9) and/or talc.

Particularly advantageous preparations are also obtained when antioxidants are used as additives or active ingredients. According to the invention, the preparations advantageously comprise one or more antioxidants. Favorable, but nevertheless optional, antioxidants which may be used are all antioxidants customary or suitable for cosmetic or dermatological applications.

For the purposes of the present invention, water-soluble antioxidants may be used particularly advantageously, such as, for example, vitamins, e.g. ascorbic acid and derivatives thereof.

Preferred antioxidants are also vitamin E and derivatives thereof, and vitamin A and derivatives thereof.

The amount of antioxidants (one or more compounds) in the preparations is preferably 0.001 to 30% by weight, particularly preferably 0.05 to 20% by weight, in particular 0.1 to 10% by weight, based on the total weight of the preparation.

If vitamin E and derivatives thereof are the antioxidant or the antioxidants, it is advantageous to choose their respective concentrations from the range from 0.001 to 10% by weight, based on the total weight of the formulation.

If vitamin A or vitamin A derivatives, or carotenes or derivatives thereof are the antioxidant or the antioxidants, it is advantageous to choose their respective concentrations from the range from 0.001 to 10% by weight, based on the total weight of the formulation.

It is particularly advantageous when the cosmetic preparations according to the present invention comprise cosmetic or dermatological active ingredients, preferred active ingredients being antioxidants which can protect the skin against oxidative stress.

Further advantageous active ingredients for the purposes of the present invention are natural active ingredients and/or derivatives thereof, such as, for example, alpha-lipoic acid, folic acid, phytoene, D-biotin, coenzyme Q10, alpha-glucosylrutin, camitine, camosine, natural and/or synthetic isoflavonoids, creatine, taurine and/or β-alanine, and 8-hexadecene-1,16-dicarboxylic acid (dioic acid, CAS number 20701-68-2; provisional INCl name Octadecenedioic acid) and/or licochalcon A.

Formulations according to the invention which comprise, for example, known anti-wrinkle active ingredients, such as flavone glycosides (in particular α-glycosylrutin), coenzyme Q10, vitamin E and/or derivatives and the like are particularly advantageously suitable for the protection from esthetically unattractive changes in the skin, as arise, for example, during the skin aging (such as, for example, dryness, roughness and formation of dryness wrinkles, itching, reduced refatting (e.g., after washing), visible vascular dilations (telangiectases, cuperosis), flaccidity and formation of wrinkles and lines, local hyperpigmentation, hypopigmentation and incorrect pigmentation (e.g., age spots), increased susceptibility to mechanical stress (e.g. cracking) and the like) and fatigued skin. In addition, they are advantageously suitable to counter the appearance of dry or rough skin.

The cosmetic preparations according to the invention can comprise cosmetic auxiliaries as are customarily used in such preparations, e.g., preservatives, preservative aids, complexing agents, bactericides, perfumes, substances for preventing or increasing foaming, dyes, pigments which have a coloring action, thickeners, moisturizing or humectant substances, fillers which improve the feel on the skin, fats, oils, waxes or other customary constituents of a cosmetic or dermatological formulation, such as alcohols, polyols, polymers, foam stabilizers, electrolytes, organic solvents or silicone derivatives.

Advantageous for the purposes of the present invention are preparations for the care of the skin: they can be used as cosmetic sunscreen, furthermore as a make-up product in decorative cosmetics.

According to their structure, cosmetic compositions for the purpose of the present invention can be used, e.g., as protective skin cream, day or night cream, etc. It is optionally possible and advantageous to use the compositions according to the invention as the basis for pharmaceutical formulations.

It is also advantageous for the purposes of the present invention to produce cosmetic preparations, the main purpose of which is not to protect against sunlight, but which nevertheless contain a content of UV protection substances. UVA or UVB filter substances are thus usually incorporated into day creams or make-up products, for example. UV protective substances, like antioxidants and, if desired, preservatives, also represent an effective protection of the preparations themselves against spoilage. Cosmetic preparations that are present in the form of a sunscreen agent are also favorable.

The use of the preparation according to the invention for protection against the aging of the skin (in particular against UV-related skin aging) and as a sunscreen agent is particularly according to the invention.

It is particularly advantageous according to the invention for the preparation according to the invention to have a pH value of 5 to 8. This can be adjusted by means of the conventional acids, bases and buffer systems.

For application, the cosmetic preparations according to the invention are applied to the skin and/or the hair in sufficient quantities in the customary manner for cosmetics.

### Comparative Tests

| Trade | | A | B | C | D | E | F |
|---|---|---|---|---|---|---|---|
| Name | Raw Material | m [%] | m [%] | m [%] | m [%] | m [%] | m [%] |
| | Polyglyceryl-3 | 1.5 | 1.5 | 1.5 | 1.5 | 1.5 | 1.5 |
| | methylglucose distearate | | | | | | |
| | Butyl | 2.0 | 2.0 | 2.0 | 2.0 | 2.0 | 2.0 |
| | methoxydibenzoylmethane | | | | | | |
| | Ethylhexyl salicylate | 5.0 | 5.0 | 5.0 | 5.0 | 5.0 | 5.0 |
| | Phenylbenzimidazole | | 3.0 | 3.0 | 3.0 | 3.0 | 3.0 |
| | sulfonic acid | | | | | | |
| | Glycerin | 7.0 | 7.0 | 7.0 | 7.0 | 7.0 | 7.0 |
| | Butylene glycol | 3.0 | 3.0 | 3.0 | 3.0 | 3.0 | 3.0 |
| | dicaprylate/dicaprate | | | | | | |
| | Copolymer of | 1.6 | 1.6 | | | | |
| | vinylpyrrolidone and | | | | | | |
| | acrylic acid | | | | | | |
| Permulen | Acrylates/C10–30 alkyl | | | | | 1.6 | |
| TR 1 | acrylate crosspolymer | | | | | | |
| Aristoflex | Ammonium | | | | 1.6 | | |
| AVC | acryloyldimethyl | | | | | | |
| | taurate/VP | | | | | | |
| | copolymer | | | | | | |
| Natrosol | Cetyl hydroxyethyl | | | | | | 1.6 |
| Plus 330 | cellulose | | | | | | |
| CS | | | | | | | |
| Ketrol F | Xanthan Gum | | | 1.6 | | | |
| | Preservatives | q.s. | q.s. | q.s. | q.s. | q.s. | q.s. |
| | Neutralizers | q.s. | q.s. | q.s. | q.s. | q.s. | q.s. |
| | Fragrance | q.s. | q.s. | q.s. | q.s. | q.s. | q.s. |
| | Water | ad 100 | ad 100 | ad 100 | ad | ad 100 | ad 100 |
| | | | | | 100 | | |
| | Viscosity in mPa * s at | >10000 | 7000 | | 3000 | | |
| | 25° C. (Haake VT02) | | | | | | |
| | Stability | Stable | Stable | In- | Stable | In- | In- |
| | | | | homogeneous | | homogeneous | homogeneous |
| | Appearance and feel | | Smooth, | Draws | Sticky | Very gritty | |
| | | | homogeneous, | threads | | | |
| | | | easily | | | | |
| | | | dispersed, | | | | |
| | | | pleasant feel | | | | |
| | | | on the skin | | | | |

### EXAMPLES

The following examples are intended to illustrate the present invention without restricting it. Unless stated otherwise, all the quantities, proportions and percentages given are based on the weight and the total quantity or on the total weight of the preparations.

| | Emulsion | | | | | | | |
|---|---|---|---|---|---|---|---|---|
| | A | B | C | D | E | F | G | H |
| Glyceryl stearate citrate | 1.5 | 1.5 | 2 | | | | | |
| Sorbitan stearate | | | | | | | 1.0 | |
| Polyglyceryl-3 | | | | 0.5 | 1.5 | 2.5 | 3.0 | 1.5 |
| methylglycose distearate | | | | | | | | |
| Cetearyl alcohol | 2 | | | | | | 1.5 | |
| Stearyl alcohol | | | 2 | | | 1 | | |
| Cetyl alcohol | | | | | | | | 3 |
| Copolymer of vinylpyrrolidone and acrylic acid | 0.5 | 1.5 | 1.0 | 3.0 | 1.6 | 1.5 | 0.8 | 2.0 |
| Acrylates/C10–30 alkyl | | | 0.3 | | | | | |
| acrylate crosspolymer | | | | | | | | |
| C_{12–15}Alkyl benzoate | | | 5 | | 3 | | | |
| Butylene glycol | 10 | | 5 | | 5 | | | |
| dicaprylate/dicaprate | | | | | | | | |
| Phenethyl benzoate | | | 3 | | | | | |
| Dicaprylyl ether | | | | | | | | |
| Octyldodecanol | 3 | | | | 3 | | 5 | |
| Dicaprylyl carbonate | | 5 | | | | | | 2 |
| Myristyl myristate | 1 | | | 2 | | | | |
| Caprylic/capric triglyceride | | 2 | | | | | 2 | 3 |
| Isodecyl neopentanoate | | | | | | | | |
| Isohexadecane | | | | | | 2 | | |
| Cyclomethicone | | | 5 | | | 3 | | 4 |
| Dimethicone | | | | | 2 | | | |
| Butylene glycol | | 2 | | | | | 5 | 8 |
| Glycerin | 2 | 5 | 10 | 5 | 7.5 | 4 | 2 | |
| C18–38 Acid triglycerides | | | 1 | | | | | |
| Bis-ethylhexyloxyphenol | | | 2 | 1 | | | 2 | |
| methoxyphenyl triazine | | | | | | | | |
| Butyl | 2.5 | | 3 | | 2 | | 5 | |
| methoxydibenzoylmethane | | | | | | | | |
| Diethylamino | | 1 | | 4 | | | | |
| hydroxybenzoyl hexyl | | | | | | | | |
| benzoate | | | | | | | | |
| Ethylhexyl | | 5 | | | | | | 7.5 |
| Methoxycinnamate | | | | | | | | |
| Octylsalicylate | 4 | | | | 5 | | | |
| Benzophenone-3 | | | | | | | | 2 |
| Phenylbenzimidazole | 3 | 2 | 1 | 4 | 2 | 1.5 | 4 | 2 |
| sulfonic acid | | | | | | | | |
| Phenylene-1,4-bis-(2-benzimidazyl)-3,3′,5,5′- | | 2 | | | | 2 | | |
| tetrasulfonic acid | | | | | | | | |
| Ethylhexyltriazine | | | 2 | | | 2 | 1 | |
| Diethylhexyl butamidotriazine | | | | | 1 | | | |
| Octodecene dicarboxylic acid | | | | | | | | 1 |
| Aluminum starch | | | | | 1 | | | |
| octenylsuccinate | | | | | | | | |
| Sodium starch | 3 | | | | | | 1.5 | |
| octenylsuccinate | | | | | | | | |
| Tapioca starch | | 2 | | | | 1 | 3 | |
| Alcohol | 0.5 | 3 | | | 5 | | | |
| Taurine | 0.1 | 0.2 | | | | 0.5 | 0.2 | |
| Folic acid | 0.01 | | 0.03 | 0.01 | | 0.02 | | 0.03 |
| Vitamin E acetate | 0.2 | 0.2 | 0.2 | | | 0.3 | 0.1 | 0.5 |
| Na₂H₂EDTA | 0.1 | 0.1 | 0.2 | | | 0.2 | 0.2 | 0.5 |
| Perfume | q.s. | q.s. | q.s. | q.s. | q.s. | q.s. | q.s. | q.s. |
| Preservatives | | | | | | | | |
| Dyes, etc. | q.s. | q.s. | q.s. | q.s. | q.s. | q.s. | q.s. | q.s. |
| Sodium hydroxide | q.s. | q.s. | q.s. | q.s. | q.s. | q.s. | q.s. | q.s. |
| Water | ad | ad | ad | ad | ad | ad | ad | ad |
| | 100.0 | 100.0 | 100.0 | 100.0 | 100.0 | 100.0 | 100.0 | 100.0 |

### O/W Emulsions

| | Emulsion | | | | | | | |
|---|---|---|---|---|---|---|---|---|
| | I | K | L | M | N | O | P | Q |
| PEG-40 Stearate | 1.5 | 2 | 0.8 | 0.5 | | | | |
| Glyceryl stearate | | 3.5 | 2.6 | | | | 2 | |
| Sodium stearoylglutamate | | | | | 0.05 | 0.1 | 0.2 | 0.5 |
| Cetearyl alcohol | | | 3 | | | | | |
| Stearyl alcohol | | | | | | | 2 | |
| Cetyl alcohol | | | | | | | | |
| Copolymer of | 1.6 | 0.5 | 1.5 | 3 | 2 | 1.6 | 0.5 | 1 |
| vinylpyrrolidone and | | | | | | | | |
| acrylic acid | | | | | | | | |
| Carbomer | | 0.2 | 0.3 | | | 0.2 | | |
| C_{12–15}Alkyl benzoate | 7 | 3 | 3 | | | 5 | 1 | 10 |
| Butylene glycol | 9 | | 3 | | 2 | 8 | | 10 |
| dicaprylate/dicaprate | | | | | | | | |
| Phenethyl benzoate | 5 | | | | | | 2 | 5 |
| Dicaprylyl ether | | | | | | | | |
| Octyldodecanol | 3 | | 5 | | | 2 | 4 | |
| Dicaprylyl carbonate | | | | 2 | | | | |
| Myristyl myristate | | | | | | | | 1 |
| Caprylic/capric triglyceride | | | | | | | 2 | |
| Isodecyl neopentanoate | | | | | 3 | | | |
| Isohexadecane | | 3 | | | | | | |
| Cyclomethicone | | | | 5 | 2 | | | |
| Dimethicone | | 5 | | | 2 | | | |
| Glycerin | 3 | 5 | 5 | 7 | 10 | 2 | 5 | 8 |
| Bis-ethylhexyloxyphenol | 3 | | | | | 1 | | 2 |
| methoxyphenyl triazine | | | | | | | | |
| Butyl | 1 | | 2.5 | | | 4 | | 3 |
| methoxydibenzoyl methane | | | | | | | | |
| Polysilicone-15 | 3 | | | | | | 2 | |
| Ethylhexyl | | 2 | 5 | | | 3 | | |
| Methoxycinnamate | | | | | | | | |
| Octylsalicylate | | | | 5 | | 3 | 2 | |
| Octocrylene | | | 4 | | | | | |
| Phenylbenzimidazole | 4 | 1 | 2 | 3 | 1 | 0.5 | 1 | 2.5 |
| sulfonic acid | | | | | | | | |
| Phenylene-1,4-bis-(2- | | 2 | | | 1 | | 3 | 0.5 |
| benzimidazyl)-3,3′,5,5′- | | | | | | | | |
| tetrasulfonic acid | | | | | | | | |
| Ethylhexyltriazine | | | | | 2 | | | 3 |
| Titanium dioxide | | | | 0.5 | 2 | | | |
| Aluminum starch | 1 | 5 | | | 2 | | | 2 |
| octenylsuccinate | | | | | | | | |
| Sodium starch | | | 2 | | | | 3 | |
| octenylsuccinate | | | | | | | | |
| Tapioca starch | | | | 3 | 2 | | | |
| Alcohol | 2 | | | 5 | | | 4 | |
| Folic acid | 0.03 | 0.01 | 0.03 | | | 0.03 | 0.02 | |
| Q10 | | | 0.03 | | 0.05 | | | |
| Na₂H₂EDTA | 0.1 | 0.1 | 0.2 | 0.1 | 0.2 | 0.2 | 0.2 | 0.5 |
| Perfume | q.s. | q.s. | q.s. | q.s. | q.s. | q.s. | q.s. | q.s. |
| Preservatives | | | | | | | | |
| Dyes, etc. | q.s. | q.s. | q.s. | q.s. | q.s. | q.s. | q.s. | q.s. |
| Sodium hydroxide | q.s. | q.s. | q.s. | q.s. | q.s. | q.s. | q.s. | q.s. |
| Water | ad | ad | ad | ad | ad | ad | ad | ad |
| | 100.0 | 100.0 | 100.0 | 100.0 | 100.0 | 100.0 | 100.0 | 100.0 |

### O/W Emulsions

| | Emulsion | | | | | | | |
|---|---|---|---|---|---|---|---|---|
| | S | T | U | V | W | X | Y | Z |
| Cetearyl alcohol + PEG-40 | 2.5 | 2.5 | 3 | | | | | |
| Castor oil + sodium | | | | | | | | |
| Cetearyl sulfate | | | | | | | | |
| Glyceryl stearate SE | 1 | 1 | 1.5 | | | | | |
| Ceteareth-20 | | | | | 1 | 0.5 | 0.5 | |
| Stearyl alcohol | | | | | | | | |
| Cetearyl alcohol | | | | | | | | |
| Cetyl alcohol | | | | | | | | |
| Acrylates/C10–30 alkyl | | | 0.3 | | | | 0.5 | 0.3 |
| Acrylate crosspolymer | | | | | | | | |
| Copolymer of | 1.5 | 1.0 | 2 | 3 | 3 | 4 | 1 | 2.5 |
| vinylpyrrolidone and | | | | | | | | |
| acrylic acid | | | | | | | | |
| C_{12–45}Alkyl benzoate | 10 | 5 | | | 4 | 3 | 2 | 5 |
| Butylene glycol | 10 | 5 | 3 | | | | 5 | 8 |
| dicaprylate/dicaprate | | | | | | | | |
| Phenethyl benzoate | | 5 | | | | | 2 | |
| Dicaprylyl ether | | | 2 | | | | | |
| Octyldodecanol | 2 | | | 2 | | 1 | | |
| Dicaprylyl carbonate | | 2 | | | 2 | | | |
| Caprylic/capric triglyceride | 3 | | | 3 | | | | |
| Isodecyl neopentanoate | | | 2 | | | | | 3 |
| Cyclomethicone | 4 | | | | 3 | | | |
| Dimethicone | | 3 | | | | | 2 | |
| Glycerin | 5 | 3 | 2 | 5 | 7 | 1 | 8 | 2 |
| VP/hexadecene | 1 | | | | | 1 | | |
| copolymer | | | | | | | | |
| C18–38 Acid triglycerides | 1 | | | | | 1 | 1 | |
| Bis-ethylhexyloxyphenol | 2 | | 1 | | | | | |
| methoxyphenyl triazine | | | | | | | | |
| Butyl | 5 | 1 | | | | 2.5 | 2.5 | 2 |
| methoxydibenzoylmethane | | | | | | | | |
| Homosalate | | | 5 | | | | 5 | |
| Ethylhexyl | | 5 | | 8 | 5 | | 5 | |
| methoxycinnamate | | | | | | | | |
| Diethylamino | | 3 | | | 2 | | | |
| hydroxybenzoyl hexylbenzoate | | | | | | | | |
| Octocrylene | 8 | | 5 | 5 | | | | |
| Octylsalicylate | | | | | | 5 | 3 | |
| Phenylbenzimidazole | 3 | 2 | 2 | 2 | 1 | 3 | 2 | 2 |
| sulfonic acid | | | | | | | | |
| Phenylene-1,4-bis-(2- | | 1 | 2 | 2 | | 3 | 2.5 | |
| benzimidazyl)-3,3′,5,5′- | | | | | | | | |
| tetrasulfonic acid | | | | | | | | |
| Ethylhexyltriazine | 3 | 2 | | | | | | 2 |
| Diethylhexyl butamidotriazine | | 2 | | | | | | |
| Benzophenon-3 | | | | | | | 2 | |
| 2,4-Bis-[5-1(dimethyl- | | | | 3 | 1 | | | |
| propyl)benzoxazol-2-yl-(4- | | | | | | | | |
| phenyl)-imino]-6-(2- | | | | | | | | |
| ethylhexyl)-imino-1,3,5-triazine | | | | | | | | |
| Titanium dioxide | 5 | | 3 | | | | | |
| Aluminum starch | | 2 | | | 0.5 | | | |
| octyenylsuccinate | | | | | | | | |
| Sodium starch | 1.5 | | 1 | | | 0.5 | | |
| octenylsuccinate | | | | | | | | |
| Tapioca starch | 3 | | | | | | | 1 |
| Alcohol | 3 | 5 | 4 | | | 4 | | 2 |
| Taurine | 0.5 | | 0.2 | | 0.6 | | 1 | 0.1 |
| Vitamin E | 1 | 0.2 | | 0.5 | | 0.3 | | 0.5 |
| Na₂H₂EDTA | 0.1 | 0.1 | 0.2 | 0.1 | 0.1 | 0.2 | 0.2 | 0.5 |
| Perfume | q.s. | q.s. | q.s. | q.s. | q.s. | q.s. | q.s. | q.s. |
| Preservative | | | | | | | | |
| Dyes, etc. | q.s. | q.s. | q.s. | q.s. | q.s. | q.s. | q.s. | q.s. |
| Sodium hydroxide | q.s. | q.s. | q.s. | q.s. | q.s. | q.s. | q.s. | q.s. |
| Water | ad | ad | ad | ad | ad | ad | ad | ad |
| | 100 | 100 | 100 | 100 | 100 | 100 | 100 | 100 |

### CROSS-REFERENCE TO RELATED APPLICATIONS

The present application expressly incorporates by reference herein in its entirety the disclosure of German Patent Application No. 10 2006 006 864.5 filed Feb. 13, 2006.

1.-10. (canceled)

11. A cosmetic preparation comprising
(a) one or more water-soluble UV photoprotective filters selected from 2-phenylbenzimidazole-5-sulfonic acid and sodium, potassium and triethanolammonium salts thereof and phenylene-1,4-bis-(2-benzimidazyl)-3,3′-5,5′-tetrasulfonic acid and sodium, potassium and triethanolammonium salts thereof;
(b) at least one copolymer of vinylpyrrolidone and acrylic acid.

12. The preparation of claim 11, wherein (a) comprises one or more of 2-phenylbenzimidazole-5-sulfonic acid and sodium, potassium and triethanolammonium salts thereof.

13. The preparation of claim 11, wherein (a) comprises one or more of phenylene-1,4-bis-(2-benzimidazyl)-3,3′-5,5′-tetrasulfonic acid and sodium, potassium and triethanolammonium salts thereof.

14. The preparation of claim 11, wherein the preparation comprises (a) in a concentration of from 0.1% to 20% by weight, based on a total weight of the preparation.

15. The preparation of claim 14, wherein the preparation comprises (a) in a concentration of not more than 10% by weight.

16. The preparation of claim 11, wherein the preparation comprises (b) in a concentration of from 0.1% to 10% by weight, based on a total weight of the preparation.

17. The preparation of claim 16, wherein the preparation comprises (b) in a concentration of not more than 5% by weight.

18. The preparation of claim 11, wherein a weight ratio (a) : (b) is from 1:15 to 15:1.

19. The preparation of claim 11, wherein (b) is cross-linked with pentaerythritol triallyl ether.

20. The preparation of claim 19, wherein (b) comprises from 25% to 80% by weight of vinylpyrrolidone, from 20% to 80% by weight of acrylic acid and from 0.4% to 2% by weight of pentaerythritol triallyl ether.

21. The preparation of claim 11, wherein the preparation further comprises one or more fuirther UV filters selected from 1,4-di(2-oxo-10-sulfo-3-bomylidene-methyl)-benzene and salts thereof; 4-(2-oxo-3-bornylidenemethyl)benzenesulfonic acid salts; 2-methyl-5-(2-oxo-3-bomylidenemethyl)sulfonic acid salts; 2,2′-methylene-bis-(6-(2H-benzotriazol-2-yl)-4-(1,1,3,3-tetramethylbutyl)-phenol); 2-(2H-benzotriazol-2-yl)-4-methyl-6-[2-methyl-3-[1,3,3,3-tetramethyl-1-[(trimethylsilyl)oxy]disiloxanyl]propyl]-phenol; 3-(4-methylbenzylidene)camphor; 3-benzylidenecamphor; ethylhexyl salicylate; terephthalidene dicamphor sulfonic acid; (2-ethylhexyl) 4-(dimethylamino)benzoate; amyl 4-(dimethylamino)benzoate; di(2-ethylhexyl) 4-methoxybenzalmalonate; (2-ethylhexyl) 4-methoxycinnamate; isoamyl 4-methoxycinnamate; 2-hydroxy-4-methoxybenzophenone, 2-hydroxy-4-methoxy-4′-methylbenzophenone; 2,2′-dihydroxy-4-methoxybenzophenone; hexyl 2-(4′-diethylamino-2′-hydoxybenzoyl)-benzoate, 4-(tert.-butyl)-4′-methoxydibenzoylmethane; homomenthyl salicylate; 2-ethylhexyl-2-hydroxybenzoate; 2-ethylhexyl-2-cyano-3,3-diphenylacrylate; dimethicodiethyl benzalmalonate; 3-(4-(2,2-bisethoxycarbonylvinyl)-phenoxy)propenyl)-methoxysiloxane/dimethyl-siloxane copolymer; 2,4-bis-{[4-(2-ethylhexyloxy)-2-hydroxy]-phenyl}-6-(4-methoxyphenyl)-1,3,5-triazine (INCI :bis-ethylhexyloxyphenol methoxyphenyl triazine); dioctylbutylamidotriazone (INCI: diethylhexyl butamidotriazone); 2,4-bis-[5-1(dimethyl-propyl)benzoxazol-2-yl-(4-phenyl)-imino]-6-(2-ethylhexyl)-imino-1,3,5-triazine with the (CAS Nr. 288254-16-0); tris(2-ethylhexyl) 4,4′,4″-(1,3,5-triazine-2,4,6-triyltriimino)-tris-benzoate (also: 2,4,6-tris-[anilino-(p-carbo-2′-ethyl-1′-hexyloxy)]-1,3,5-triazine (INCI: ethylhexyl triazone); 2,4,6-tribiphenyl-4-yl-1,3,5-triazine; merocyanine; titanium dioxide; zinc oxide in a concentration of from 0.01% to 40% by weight, based on a total weight of the preparation.

22. The preparation of claim 11, wherein the preparation further comprises one or more additional water-soluble salts in a concentration of from 0.001% to 10% by weight, based on a total weight of the preparation.

23. The preparation of claim 11, wherein the preparation is free from fatty alcohols.

24. A cosmetic preparation comprising, based on a total weight of the preparation:
(a) from 0.1% to 20% by weight of one or more water-soluble UV photoprotective filters selected from 2-phenylbenzimidazole-5-sulfonic acid and sodium, potassium and triethanolammonium salts thereof and phenylene-1,4-bis-(2-benzimidazyl)-3,3′-5,5′-tetrasulfonic acid and sodium, potassium and triethanolammonium salts thereof;
(b) from 0.1% to 10% by weight of at least one copolymer of vinylpyrrolidone and acrylic acid.

25. The preparation of claim 24, wherein the preparation comprises not more than 10% by weight of (a) and not more than 5% by weight of (b).

26. The preparation of claim 25, wherein a weight ratio (a) : (b) is from 1:15 to 15:1.

27. The preparation of claim 25, wherein (b) is cross-linked with pentaerythritol triallyl ether.

28. The preparation of claim 27, wherein (b) comprises from 25% to 80% by weight of vinylpyrrolidone, from 20% to 80% by weight of acrylic acid and from 0.4% to 2% by weight of pentaerythritol triallyl ether.

29. The preparation of claim 11, wherein the preparation is present as an emulsion.

30. The preparation of claim 29, wherein the emulsion is an O/W emulsion.
